(19) United States
(12) Patent Application Publication
(10) Pub. No.: US 2024/0039122 A1
(43) Pub. Date: Feb. 1, 2024

(54) BATTERY

(71) Applicant: Prime Planet Energy & Solutions, Inc., Tokyo (JP)

(72) Inventors: Taisuke ISEDA, Kobe-shi (JP); Akira NISHIDA, Himeji-shi (JP)

(21) Appl. No.: 18/359,872

(22) Filed: Jul. 27, 2023

(30) Foreign Application Priority Data
Jul. 28, 2022 (JP) 2022-120872

(51) Int. Cl. H01M 50/46; H01M 50/636; H01M 50/342; H01M 4/525; H01M 4/62

(52) U.S. Cl. CPC H01M 50/461; H01M 50/636; H01M 50/342; H01M 4/525; H01M 4/621

(57) ABSTRACT

A battery disclosed herein includes an electrode body including a positive electrode including a positive electrode active material layer, a negative electrode, and a separator. The separator includes an adhesive layer on a surface that faces the positive electrode. The adhesive layer includes a first formation region provided so as to face the positive electrode active material layer, and a second formation region provided so as to protrude outward, in an up-down direction or a long side direction of the battery, relative to one end part of the positive electrode active material layer. The first formation region has smaller weight per area than the second formation region.

### CROSS REFERENCE TO RELATED APPLICATION

This application claims the benefit of priority to Japanese Patent Application No. 2022-120872 filed on Jul. 28, 2022. The entire contents of this application are hereby incorporated herein by reference.

### BACKGROUND OF THE DISCLOSURE

### 1. Field

The present disclosure relates to a battery.

### 2. Background

One of the conventionally known batteries includes an electrode body including a positive electrode including a positive electrode active material layer, a negative electrode including a negative electrode active material layer, and a separator, and a battery case with a cuboid shape for accommodating the electrode body. For example, Japanese Patent No. 5328034 discloses an electrode body in which at least one of a positive electrode and a negative electrode is unified with a separator with an adhesive applied on an entire surface of the separator, and a battery including the electrode body.

### SUMMARY

The present inventors' examination indicates, however, the application of the adhesive on the entire surface of the separator results in a problem of an increase in internal resistance because impregnation of the electrode body with an electrolyte solution becomes difficult and due to the thickness of the adhesive, the positive electrode and the negative electrode are spaced apart more. The present disclosure has been made in view of the above circumstances and an object of the present disclosure is to provide a battery with reduced internal resistance, in which the disadvantage from formation of an adhesive layer is suppressed.

A battery according to the present disclosure includes an electrode body including a positive electrode including a positive electrode active material layer, a negative electrode including a negative electrode active material layer, and a separator, and a battery case with a cuboid shape for accommodating the electrode body. The separator includes an adhesive layer at least on a surface that faces the positive electrode. The adhesive layer includes a first formation region provided so as to face the positive electrode active material layer, and a second formation region provided so as to protrude outward, in an up-down direction or a long side direction of the battery, relative to one end part of the positive electrode active material layer that faces the first formation region, and the adhesive layer in the first formation region has smaller weight per area than the adhesive layer in the second formation region.

When the first formation region facing the positive electrode active material layer has smaller weight per area than the second formation region that protrudes outward relative to the end part of the positive electrode active material layer, a disadvantage from formation of the adhesive layer on the separator can be suppressed. That is to say, compared to a case where an adhesive is applied all over the surface of the separator, the impregnation of the electrode body (in particular, positive electrode active material layer) with an electrolyte solution can be improved and the internal resistance can be reduced relatively by reducing the distance between the positive and negative electrodes.

In addition, when the weight per area of the second formation region is relatively large, an advantage from the formation of the adhesive layer on the separator can be obtained. For example, when the adhesive layer of the separator is attached to the positive electrode, peel-off of the separator can be suppressed and the workability at construction of the battery can be improved. Furthermore, the mixing of a foreign substance between the separator and the positive electrode can be suppressed. Accordingly, the occurrence of micro short-circuiting caused by a metal foreign substance that melts due to potential increase of the positive electrode particularly at charging and precipitates on the negative electrode can be suppressed. Furthermore, the separator will not be displaced easily under the impact at the vibration or drop, for example, during the use of the battery, and thus, the vibration resistance can be improved. As a result, by the art disclosed herein, the advantage from the formation of the adhesive layer can be obtained while the disadvantage from the formation of the adhesive layer is suppressed.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a battery according to a first embodiment;

FIG. 2 is a schematic longitudinal cross-sectional view taken along line II-II in FIG. 1;

2;

FIG. 3 is a schematic lateral cross-sectional view taken along line in FIG. 1;

FIG. 4 is a schematic longitudinal cross-sectional view taken along line IV-IV in FIG.

FIG. 5 is a schematic view illustrating a structure of a wound electrode body according to the first embodiment;

FIG. 6 is a magnified view schematically illustrating interfaces among a positive electrode, a negative electrode, and a separator;

FIG. 7 is a plan view illustrating a surface of the separator on a side that faces the positive electrode;

FIG. 8 is a schematic view illustrating an upper end part of the positive electrode accommodated in the battery case;

FIG. 9 is a schematic view illustrating a lower end part of the positive electrode accommodated in the battery case;

FIG. 10 is a diagram corresponding to FIG. 2 and illustrates a battery according to a second embodiment;

FIG. 11 is a diagram corresponding to FIG. 6 and illustrates a structure of a wound electrode body according to the second embodiment;

FIG. 12 is a diagram corresponding to FIG. 7 and illustrates a separator according to a first modification;

FIG. 13 is a diagram corresponding to FIG. 7 and illustrates a separator according to a second modification; and

FIG. 14 is a diagram corresponding to FIG. 7 and illustrates a separator according to a third modification.

### DETAILED DESCRIPTION OF THE PREFERRED EMBODIMENTS

Embodiments of the art disclosed herein will be described below with reference to the drawings. Incidentally, matters other than matters particularly mentioned in the present specification, and necessary for the implementation of the art disclosed herein (for example, the general configuration and manufacturing process of a battery that do not characterize the present disclosure) can be grasped as design matters of those skilled in the art based on the conventional art in the relevant field. The art disclosed herein can be implemented on the basis of the disclosure of the present specification and common technical knowledge in the relevant field. In the present specification, the notation “A to B” for a range signifies “a value more than or equal to A and less than or equal to B”, and is meant to encompass also the meaning of being “more than A” and “less than B”.

Note that in the present specification, “battery” is a term that refers to a general power storage device capable of extracting electric energy, and refers to a concept that includes a primary battery and a secondary battery. In the present specification, “secondary battery” refers to a general power storage device capable of being repeatedly charged and discharged by transfer of charge carriers between a positive electrode and a negative electrode through an electrolyte. The electrolyte may be any one of a liquid electrolyte (electrolyte solution), a gel electrolyte, and a solid electrolyte. The secondary battery includes so-called power storage batteries (chemical batteries) such as lithium ion secondary batteries and nickel-hydrogen batteries, and moreover includes capacitors (physical batteries) such as electrical double-layer capacitors, for example. A target in embodiments to be described below is a lithium ion secondary battery.

### First Embodiment

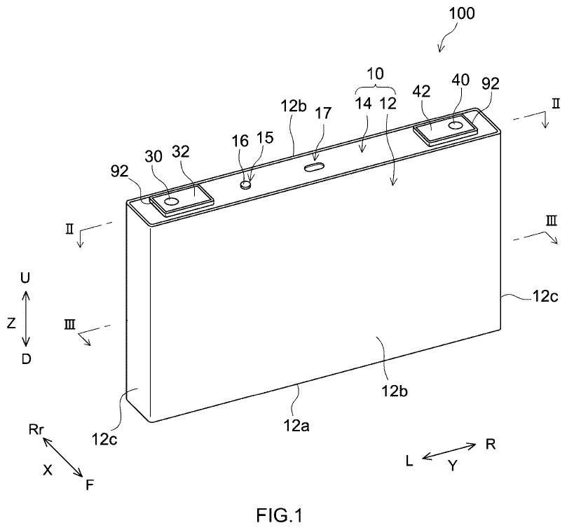

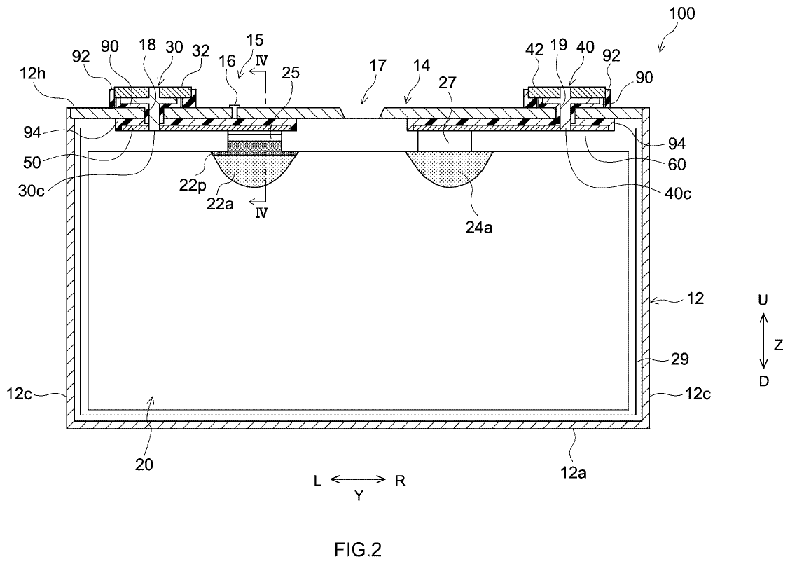

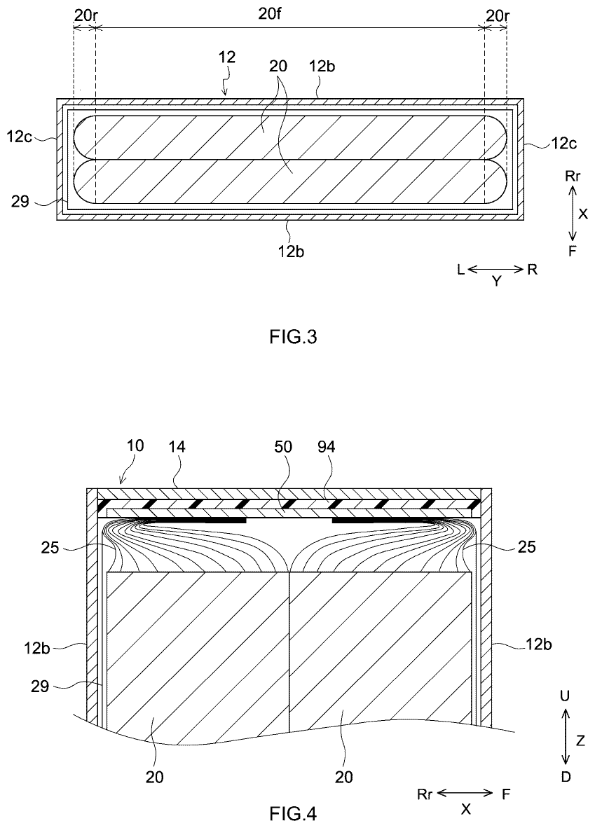

FIG. 1 is a perspective view schematically illustrating a battery 100 according to a first embodiment. The battery 100 is preferably a secondary battery, and more preferably a nonaqueous electrolyte secondary battery such as a lithium ion secondary battery. FIG. 2 is a schematic longitudinal cross-sectional view taken along line II-II in FIG. 1. FIG. 3 is a schematic lateral cross-sectional view taken along line in FIG. 1. FIG. 4 is a schematic longitudinal cross-sectional view taken along line IV-IV in FIG. 2. In the following description, reference signs L, R, F, Rr, U, and D in the drawings respectively denote left, right, front, rear, up, and down. In addition, a reference sign X in the drawings denotes a short side direction of the battery 100, a reference sign Y denotes a long side direction of the battery 100, and a reference sign Z denotes an up-down direction of the battery 100. These directions are defined however for convenience of explanation, and do not limit the manner in which the battery 100 is disposed.

As illustrated in FIG. 1 to FIG. 3, the battery 100 includes a battery case 10 (see FIG. 1), a plurality of wound electrode bodies 20 (see FIG. 2 and FIG. 3), a positive electrode terminal 30 (see FIG. 1 and FIG. 2), a negative electrode terminal 40 (see FIG. 1 and FIG. 2), a positive electrode current collecting part 50 (see FIG. 2), and a negative electrode current collecting part 60 (see FIG. 2). Although illustration is omitted, the battery 100 further includes an electrolyte solution here. The battery 100 is a nonaqueous electrolyte secondary battery. A specific structure of the battery 100 is hereinafter described.

The battery case 10 is a housing that accommodates the wound electrode bodies 20. As illustrated in FIG. 1, the external shape of the battery case 10 here is a flat and bottomed cuboid shape (rectangular shape). A conventionally used material can be used for the battery case 10, without particular limitations. The battery case 10 is preferably made of metal, and for example, more preferably made of aluminum, an aluminum alloy, iron, an iron alloy, or the like. As illustrated in FIG. 2, the battery case 10 includes an exterior body 12 having an opening 12h, and a sealing plate (lid body) 14 that seals the opening 12h. Each of the exterior body 12 and the sealing plate 14 has the size in accordance with the number of wound electrode bodies 20 to be accommodated (one or more, here more than one) and the size of the wound electrode bodies 20, for example.

As can be seen from FIG. 1 and FIG. 2, the exterior body 12 is a bottomed and rectangular container with the opening 12h on an upper surface thereof. As illustrated in FIG. 1, the exterior body 12 includes a bottom wall 12a, a pair of long side walls 12b extending upward from long sides of the bottom wall 12a and facing each other, and a pair of short side walls 12c extending upward from short sides of the bottom wall 12a and facing each other. The bottom wall 12a is substantially rectangular in shape. The bottom wall 12a faces the opening 12h (see FIG. 2). The long side walls 12b and the short side walls 12c are one example of “side wall”. The sealing plate 14 is a plate-shaped member that is attached to the exterior body 12 so as to cover the opening 12h of the exterior body 12, and is substantially rectangular in a plan view. The sealing plate 14 faces the bottom wall 12a of the exterior body 12. The sealing plate 14 is substantially rectangular in shape. The battery case 10 is unified in a manner that the sealing plate 14 is joined (for example, joined by welding) to a periphery of the opening 12h of the exterior body 12. In this way, the battery case 10 is hermetically sealed (closed).

As illustrated in FIG. 2, a liquid injection hole 15, a gas discharge valve 17, and terminal extraction holes 18 and 19 are provided in the sealing plate 14. The liquid injection hole 15 is a penetration hole for injecting the electrolyte solution inside the battery case 10 after the sealing plate 14 is assembled to the exterior body 12. The liquid injection hole 15 is sealed by a sealing member 16 after the injection of the electrolyte solution. The gas discharge valve 17 is a thin part that is configured to break when the pressure in the battery case 10 becomes more than or equal to a predetermined value so as to discharge the gas out of the battery case 10.

The electrolyte solution may be any electrolyte solution used in the conventionally known batteries, without particular limitations. One example thereof is a nonaqueous electrolyte solution in which a supporting salt is dissolved in a nonaqueous solvent. Examples of the nonaqueous solvent include carbonate solvents such as ethylene carbonate, dimethyl carbonate, and ethyl methyl carbonate. One example of the supporting salt is fluorine-containing lithium salt such as LiPF₆. The electrolyte solution may contain an additive as necessary.

The positive electrode terminal 30 is attached to one end part of the sealing plate 14 in the long side direction Y (left end part in FIG. 1 and FIG. 2). The negative electrode terminal 40 is attached to the other end part of the sealing plate 14 in the long side direction Y (right end part in FIG. 1 and FIG. 2). The positive electrode terminal 30 and the negative electrode terminal 40 are inserted into the terminal extraction holes 18 and 19 and are exposed to an external surface of the sealing plate 14. The positive electrode terminal 30 is electrically connected to a positive electrode external conductive member 32 with a plate shape outside the battery case 10. The negative electrode terminal 40 is electrically connected to a negative electrode external conductive member 42 with a plate shape outside the battery case 10. The positive electrode external conductive member 32 and the negative electrode external conductive member 42 are connected to other secondary battery or external device through an external connection member such as a busbar. The positive electrode external conductive member 32 and the negative electrode external conductive member 42 are preferably formed of metal with excellent conductivity, such as aluminum, an aluminum alloy, copper, or a copper alloy. However, the positive electrode external conductive member 32 and the negative electrode external conductive member 42 are not always necessary and can be omitted in another embodiment.

As illustrated in FIG. 3 and FIG. 4, the battery 100 according to the present embodiment includes a plurality of (specifically, two) wound electrode bodies 20 within the battery case 10. The number of wound electrode bodies to be disposed in one exterior body 12 is, however, not limited in particular and may be three or more (plural), or one. As for the detailed structure of the wound electrode body 20, which is described below, a positive electrode tab group 25 and a negative electrode tab group 27 protrude over the wound electrode body 20 as illustrated in FIG. 2. The battery 100 has a so-called upper tab structure in which the positive electrode tab group 25 and the negative electrode tab group 27 exist over the wound electrode body 20. As illustrated in FIG. 4, the positive electrode tab group 25 is bent while being bonded with the positive electrode current collecting part 50. Although the illustration is omitted, the negative electrode tab group 27 is similarly bent while being bonded with the negative electrode current collecting part 60.

The positive electrode current collecting part 50 electrically connects between the positive electrode terminal 30 and the positive electrode tab group 25 of the wound electrode body 20. As illustrated in FIG. 2, the positive electrode current collecting part 50 is a plate-shaped conductive member extending in the long side direction Y along an inner side surface of the sealing plate 14. One end part (right side in FIG. 2) of the positive electrode current collecting part 50 is electrically connected to the positive electrode tab group 25. The other end part (left side in FIG. 2) of the positive electrode current collecting part 50 is electrically connected to a lower end part 30c of the positive electrode terminal 30. The positive electrode terminal 30 and the positive electrode current collecting part 50 are preferably formed of metal with excellent conductivity, such as aluminum or an aluminum alloy.

The negative electrode current collecting part 60 electrically connects between the negative electrode terminal 40 and the negative electrode tab group 27 of the wound electrode body 20. As illustrated in FIG. 2, the negative electrode current collecting part 60 is a plate-shaped conductive member extending in the long side direction Y along the inner side surface of the sealing plate 14. One end part (left side in FIG. 2) of the negative electrode current collecting part 60 is electrically connected to the negative electrode tab group 27. The other end part (right side in FIG. 2) of the negative electrode current collecting part 60 is electrically connected to a lower end part 40c of the negative electrode terminal 40. The negative electrode terminal 40 and the negative electrode current collecting part 60 are preferably formed of metal with excellent conductivity, such as copper or a copper alloy. For the battery 100, various insulating members are used to prevent conduction between the wound electrode body 20 and the battery case 10. For example, as illustrated in FIG. 1, the positive electrode external conductive member 32 and the negative electrode external conductive member 42 are insulated from the sealing plate 14 by an external insulating member 92. Additionally, as illustrated in FIG. 2, a gasket 90 is attached to each of the terminal extraction holes 18 and 19 of the sealing plate 14. Thus, the conduction between the sealing plate 14, and the positive electrode terminal 30 and the negative electrode terminal 40 inserted into the terminal extraction holes 18 and 19 can be prevented. Moreover, between the positive electrode current collecting part 50 and the negative electrode current collecting part 60, and the inner surface side of the sealing plate 14, an internal insulating member 94 is disposed. Thus, the conduction between the positive electrode current collecting part 50 and the negative electrode current collecting part 60, and the sealing plate 14 can be prevented. The internal insulating member 94 may include a protrusion part that protrudes toward the wound electrode body 20, which will be described below in a second embodiment.

Moreover, the wound electrode bodies 20 are disposed inside the exterior body 12 in a state of being covered with an electrode body holder 29 made of an insulating resin sheet (see FIG. 3). Thus, the direct contact between the wound electrode body 20 and the exterior body 12 can be prevented. Note that the material of each insulating member described above is not limited in particular as long as the material has a predetermined insulating property. Examples of such a material include synthetic resin materials including polyolefin resins such as polypropylene (PP) and polyethylene (PE), and fluorine resins such as perfluoroalkoxy alkane and polytetrafluoroethylene (PTFE).

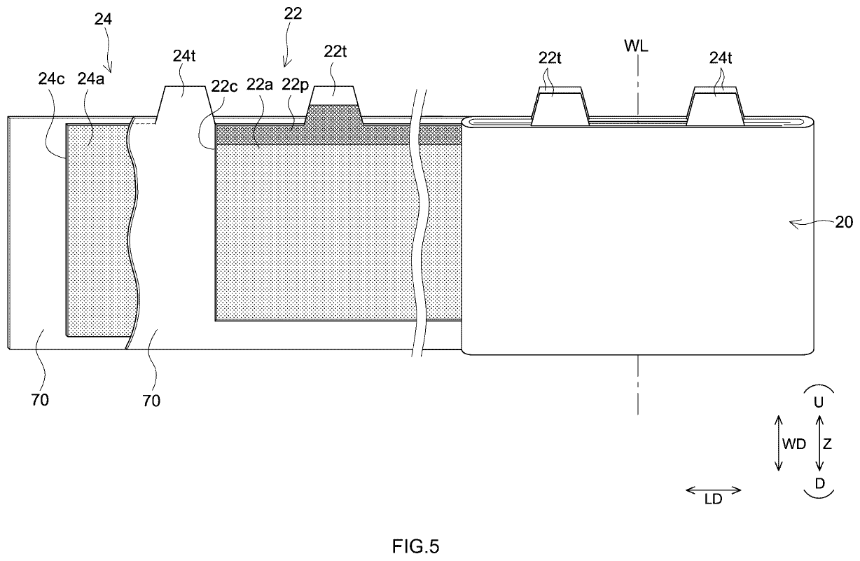

FIG. 5 is a schematic view illustrating a structure of the wound electrode body 20. As illustrated in FIG. 5, the wound electrode body 20 has a structure in which a positive electrode 22 with a band shape and a negative electrode 24 with a band shape are stacked in an insulated state across two separators 70 with a band shape and wound in a longitudinal direction using a winding axis WL as a center. A reference sign LD in FIG. 5, etc. denotes the longitudinal direction (that is, conveying direction) of the wound electrode body 20 and the separator 70 that are manufactured into the band shape. A reference sign WD denotes a direction that is substantially orthogonal to the longitudinal direction LD and corresponds to a winding axis direction (also width direction) of the wound electrode body 20 and the separator 70. In the present embodiment, the winding axis direction WD is substantially parallel to the up-down direction Z of the battery 100 described above.

The external shape of the wound electrode body 20 is a flat shape here. The wound electrode body 20 preferably has a flat shape. The wound electrode body 20 with the flat shape can be formed by, for example, press-molding an electrode body wound into a tubular shape (tubular body) in a flat shape. The wound electrode body 20 with a flat shape includes a pair of curved parts 20r whose outer surface is curved and a pair of flat parts 20f whose outer surface is flat for coupling the pair of curved parts 20r as illustrated in FIG. 3.

In the battery 100, the wound electrode body 20 is accommodated inside the battery case 10 so that the winding axis direction WD substantially coincides with the up-down direction Z. In other words, the wound electrode body 20 is disposed inside the battery case 10 so that the winding axis direction WD is substantially parallel to the long side walls 12b and the short side walls 12c and is substantially orthogonal to the bottom wall 12a and the sealing plate 14. As illustrated in FIG. 3, the pair of curved parts 20r face the pair of short side walls 12c of the exterior body 12. The pair of flat parts 20f face the long side walls 12b of the exterior body 12. End surfaces of the wound electrode body 20 (that is, stacked surfaces where the positive electrode 22 and the negative electrode 24 are stacked, opposite end parts in the winding axis direction WD in FIG. 5) face the bottom wall 12a and the sealing plate 14.

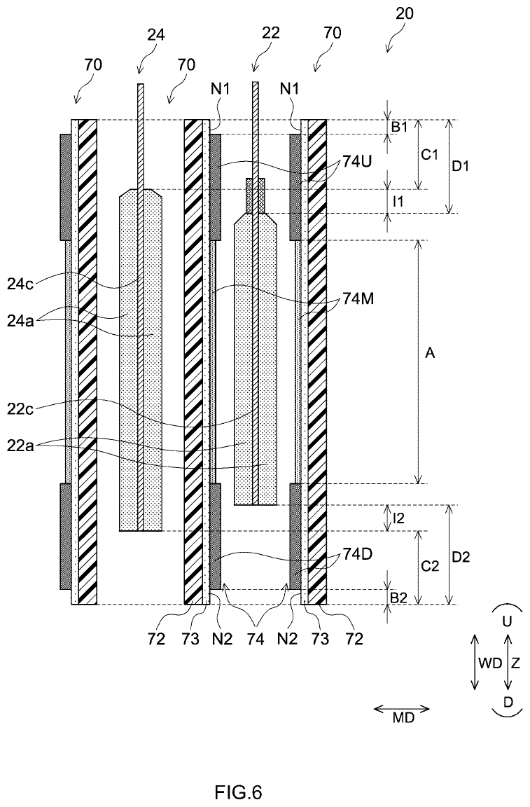

FIG. 6 is a magnified view schematically illustrating interfaces among the positive electrode 22, the negative electrode 24, and the separator 70 in the wound electrode body 20. Note that a reference sign MD in FIG. 6 denotes a stacking direction of the wound electrode body 20, and corresponds to a direction that is substantially parallel to the short side direction X of the battery 100 described above. A specific structure of the wound electrode body 20 in the present embodiment is hereinafter described.

The positive electrode 22 is a band-shaped member as illustrated in FIG. 5. The positive electrode 22 includes a positive electrode current collector 22c with a band shape, and a positive electrode active material layer 22a and a positive electrode protection layer 22p that are fixed on at least one surface of the positive electrode current collector 22c. As illustrated in FIG. 6, the positive electrode 22 faces an adhesive layer 74 of the separator 70. At least a part of the positive electrode 22 is attached to the separator 70. The positive electrode active material layer 22a is preferably formed on both surfaces of the positive electrode current collector 22c from the viewpoint of the battery performance.

For each member of the positive electrode 22, conventionally known materials that can be used for general batteries (for example, lithium ion secondary batteries) can be used without particular limitations. For example, the positive electrode current collector 22c is preferably formed of conductive metal such as aluminum, an aluminum alloy, nickel, or stainless steel, and here, a metal foil, specifically an aluminum foil is used.

As illustrated in FIG. 5, in the positive electrode 22, a plurality of positive electrode tabs 22t protrude from one end side in the winding axis direction WD to the outside (upper side in FIG. 5). The direction where the positive electrode tabs 22t protrude is substantially the same as the winding axis direction WD. The positive electrode tabs 22t are provided with a predetermined space (intermittently) along the longitudinal direction LD. The positive electrode tabs 22t constitute a part of the positive electrode 22 here. The positive electrode tab 22t is a region where the positive electrode active material layer 22a is not formed. In a part of the positive electrode tabs 22t, here, the positive electrode protection layer 22p is provided. However, the positive electrode protection layer 22p may be omitted in the positive electrode tabs 22t. In at least a part of the positive electrode tabs 22t, the positive electrode current collector 22c is exposed. The positive electrode tabs 22t and the positive electrode 22 may be different members.

Each of the positive electrode tabs 22t has a trapezoidal shape here. The shape of the positive electrode tab 22t is, however, not limited to this shape. Moreover, the size of the positive electrode tabs 22t is not limited in particular. The shape and size of the positive electrode tab 22t can be adjusted as appropriate depending on the formation position and the like in consideration of, for example, how the positive electrode tab 22t is connected to the positive electrode current collecting part 50. The positive electrode tabs 22t are stacked at one end part of the positive electrode 22 in the winding axis direction WD (upper end part in FIG. 5) and form the positive electrode tab group 25 (see FIG. 2).

The positive electrode active material layer 22a is formed to have a band shape along the longitudinal direction LD of the positive electrode current collector 22c as illustrated in FIG. 5. The width of the positive electrode active material layer 22a (the length in the winding axis direction WD, which similarly applies to the description below) is smaller than the width of a negative electrode active material layer 24a. The positive electrode active material layer 22a includes a positive electrode active material that is capable of reversibly storing and releasing charge carriers. The positive electrode active material is preferably a lithium-transition metal complex oxide, and more preferably contains Ni. Examples of the lithium-transition metal complex oxide containing Ni include a lithium-nickel-cobalt-manganese complex oxide. Furthermore, the positive electrode active material layer 22a may contain an optional component other than the positive electrode active material, such as a binder, a conductive material, or various additive components. The positive electrode active material layer 22a preferably contains the binder and the conductive material in addition to the positive electrode active material. The binder is typically made of resin and preferably a fluorine resin such as polyvinylidene fluoride (PVdF) in particular. The conductive material is preferably a carbon material such as acetylene black (AB).

The positive electrode protection layer 22p is a layer formed to have lower electric conductivity than the positive electrode active material layer 22a. The positive electrode protection layer 22p is provided in a band shape along the longitudinal direction LD of the positive electrode current collector 22c as illustrated in FIG. 5. The positive electrode protection layer 22p is provided at a border part between the positive electrode current collector 22c and the positive electrode active material layer 22a in the winding axis direction WD. The positive electrode protection layer 22p is provided at one end part of the positive electrode current collector 22c in the winding axis direction WD, specifically at an end part on the side where the positive electrode tabs 22t exist (upper end part in FIG. 5), here. The provision of the positive electrode protection layer 22p can prevent the internal short-circuiting of the battery 100 due to the direct contact between the positive electrode 22 and the negative electrode active material layer 24a at the damage of the separator 70.

The positive electrode protection layer 22p contains inorganic filler with an insulation property. One example of the inorganic filler is ceramic particles of alumina or the like. The positive electrode protection layer 22p may contain an optional component other than the inorganic filler, such as a binder, a conductive material, or various additive components. The binder and the conductive material may be the same as those described as the examples that may be contained in the positive electrode active material layer 22a. However, the positive electrode protection layer 22p is not always necessary and can be omitted in another embodiment.

The negative electrode 24 is a band-shaped member as illustrated in FIG. 5. The negative electrode 24 includes a negative electrode current collector 24c with a band shape, and the negative electrode active material layer 24a that is fixed on at least one surface of the negative electrode current collector 24c. As illustrated in FIG. 6, the negative electrode 24 faces a base material layer 72 of the separator 70 here. The negative electrode 24 may be attached to the base material layer 72 of the separator 70. The negative electrode active material layer 24a is preferably formed on both surfaces of the negative electrode current collector 24c from the viewpoint of the battery performance.

For each member of the negative electrode 24, conventionally known materials that can be used for general batteries (for example, lithium ion secondary batteries) can be used without particular limitations. For example, the negative electrode current collector 24c is preferably formed of conductive metal such as copper, a copper alloy, nickel, or stainless steel, and here, a metal foil, specifically a copper foil is used.

As illustrated in FIG. 5, in the negative electrode 24, negative electrode tabs 24t protrude from one end side in the winding axis direction WD to the outside (upper side in FIG. 5). The negative electrode tabs 24t are provided with a predetermined space (intermittently) along the longitudinal direction LD. The negative electrode tab 24t is provided at the end part on the same side as the positive electrode tab 22t in the winding axis direction WD. The negative electrode tabs 24t constitute a part of the negative electrode 24 here. The negative electrode tab 24t is a region where the negative electrode active material layer 24a is not formed and the negative electrode current collector 24c is exposed. However, a part of the negative electrode active material layer 24a may protrude and adhere to the negative electrode tab 24t. Alternatively, the negative electrode tab 24t and the negative electrode 24 may be different members.

Each of the negative electrode tabs 24t has a trapezoidal shape here. However, the shape and size of the negative electrode tabs 24t can be adjusted as appropriate similarly to the positive electrode tabs 22t. The negative electrode tabs 24t are stacked at one end part of the negative electrode 24 in the winding axis direction WD (upper end part in FIG. 5) and form the negative electrode tab group 27 (see FIG. 2).

The negative electrode active material layer 24a is formed to have a band shape along the longitudinal direction LD of the negative electrode current collector 24c as illustrated in FIG. 5. The width of the negative electrode active material layer 24a is larger than that of the positive electrode active material layer 22a. Note that the width of the negative electrode active material layer 24a refers to the length of a part with substantially constant thickness in the winding axis direction WD, and for example, even when a part of the negative electrode active material layer 24a protrudes and adheres to the negative electrode tab 24t, this part of the negative electrode tab 24t is not included. The negative electrode active material layer 24a includes a negative electrode active material that is capable of reversibly storing and releasing the charge carriers. The negative electrode active material is preferably, for example, a carbon material such as graphite or a silicon material. The negative electrode active material layer 24a may contain an optional component other than the negative electrode active material, such as a binder, a conductive material, or various additive components. The negative electrode active material layer 24a preferably contains the binder in addition to the negative electrode active material. The binder preferably contains rubbers such as styrene butadiene rubber (SBR) or celluloses such as carboxymethyl cellulose (CMC). The negative electrode active material layer 24a may contain a carbon material as the conductive material as necessary.

As illustrated in FIG. 5, the separator 70 is a band-shaped member. The separator 70 is an insulating sheet including a plurality of small penetration holes through which the charge carriers can pass. The width of the separator 70 is larger than that of the negative electrode active material layer 24a. The provision of the separator 70 between the positive electrode 22 and the negative electrode 24 can prevent the contact between the positive electrode 22 and the negative electrode 24, and enables the charge carriers (such as lithium ion) to move between the positive electrode 22 and the negative electrode 24.

Here, two separators 70 are used for one wound electrode body 20. As described in this embodiment, one wound electrode body 20 preferably includes two separators 70, that is, a first separator and a second separator. The art disclosed herein is applied to at least one of the first separator and the second separator, and is preferably applied to both. Moreover, the two separators, which have the similar structure here, may have different structures.

As illustrated in FIG. 6, the separator 70 includes the base material layer 72 and the adhesive layer 74 formed on a surface of the base material layer 72 that faces the positive electrode 22. Here, a heat-resistant layer 73 is additionally provided between the base material layer 72 and the adhesive layer 74. The adhesive layer 74 forms an outermost surface on the side facing the positive electrode 22. The separator 70 is unified with the positive electrode 22 in a manner that, for example, the adhesive layer 74 is attached to (for example, crimped to) the positive electrode 22 by heating, press-molding, or the like. This makes it difficult for the separator 70 to peel off and the workability at the construction of the battery 100 can be improved. Moreover, the mixing of a foreign substance between the separator 70 and the positive electrode 22 can be suppressed and the occurrence of micro short-circuiting caused by a metal foreign substance can be suppressed. Furthermore, the separator 70 will not be displaced easily under the impact at the vibration or drop, for example, during the use of the battery 100, and thus, the vibration resistance can be improved.

The separator 70 may include the heat-resistant layer 73 and/or the adhesive layer 74 on the surface facing the negative electrode 24, or may exclude the heat-resistant layer 73 and/or the adhesive layer 74 on the surface facing the negative electrode 24. As illustrated in FIG. 6, the separator 70 here includes neither the heat-resistant layer 73 nor the adhesive layer 74 on the surface facing the negative electrode 24. The base material layer 72 forms the outermost surface on the side facing the negative electrode 24 here. The negative electrode 24 preferably faces the base material layer 72. The separator 70 may adhere to the negative electrode 24 through the base material layer 72, for example.

As the base material layer 72, a microporous film that can be used for the separators of the conventionally known batteries can be used without particular limitations. The base material layer 72 is preferably formed of a porous sheet-shaped member. The base material layer 72 may have a single-layer structure or a structure including two or more layers, for example three layers. Regarding the base material layer 72, at least a surface thereof that faces the negative electrode 24 is preferably formed of a polyolefin resin. The base material layer 72 is more preferably formed of the polyolefin resin entirely. Thus, the flexibility of the separator 70 can be secured sufficiently, and the manufacture (winding and press-molding) of the wound electrode body 20 can be performed easily. As the polyolefin resin, polyethylene (PE), polypropylene (PP), or a mixture thereof is preferable and PE is more preferable.

Although not particularly limited, the thickness of the base material layer 72 (length in a stacking direction MD, this similarly applies to the description below) is preferably 3 to 25 more preferably 3 to 18 and still more preferably 5 to 14 The air permeance of the base material layer 72 is preferably 30 to 500 sec/100 cc, more preferably 30 to 300 sec/100 cc, and still more preferably 50 to 200 sec/100 cc. The base material layer 72 may have the adhesiveness of such a degree that the base material layer 72 is attached to the negative electrode active material layer 24a by heating, press-molding, or the like, for example.

The heat-resistant layer 73 is provided on the base material layer 72. The heat-resistant layer 73 is preferably formed on the base material layer 72. The heat-resistant layer 73 may be provided directly on the surface of the base material layer 72 or may be provided on the base material layer 72 through another layer. However, the heat-resistant layer 73 is not always necessary and can be omitted in another embodiment. The heat-resistant layer 73 is provided on the entire surface of the base material layer 72 that faces the positive electrode 22. Thus, the thermal contraction of the separator 70 can be suppressed more suitably and the safety of the battery 100 can be improved. The heat-resistant layer 73 does not have the adhesiveness of such a degree that the heat-resistant layer 73 is attached to the positive electrode active material layer 22a by heating, press-molding, or the like, for example. The weight per area of the heat-resistant layer 73 is uniform in the longitudinal direction LD and the winding axis direction WD of the separator 70. Although not particularly limited, the thickness of the heat-resistant layer 73 is preferably 0.3 to 6 more preferably 0.5 to 6 and still more preferably 1 to 4 The heat-resistant layer 73 preferably contains inorganic filler and a heat-resistant layer binder.

As the inorganic filler, the conventionally known ones that have been used in this kind of application can be used without particular limitations. The inorganic filler preferably contains insulating ceramic particles. In particular, in consideration of the heat resistance, the availability, and the like, inorganic oxides such as alumina, zirconia, silica, and titania, metal hydroxides such as aluminum hydroxide, and clay minerals such as boehmite are preferable, and alumina and boehmite are more preferable. From the viewpoint of suppressing the thermal contraction of the separator 70, a compound containing aluminum is particularly preferable. The ratio of the inorganic filler to the total mass of the heat-resistant layer 73 is preferably 85 mass % or more, more preferably 90 mass % or more, and still more preferably 95 mass % or more.

As the heat-resistant layer binder, the conventionally known ones that have been used in this kind of application can be used without particular limitations. Specific examples thereof include an acrylic resin, a fluorine resin, an epoxy resin, a urethane resin, an ethylene vinyl acetate resin, and the like. In particular, the acrylic resin is preferable.

The adhesive layer 74 is provided on the surface that faces the positive electrode 22 and is in contact with the positive electrode 22. As illustrated in FIG. 6, the adhesive layer 74 is preferably formed on at least the surface of the separator 70 on the side of the positive electrode 22. Thus, the effect as described above can be achieved more. The adhesive layer 74 is attached to the positive electrode 22 by, for example, heating, pressing (typically press-molding), or the like.

The adhesive layer 74 is provided on the heat-resistant layer 73, here. The adhesive layer 74 is preferably formed on the heat-resistant layer 73. The adhesive layer 74 may be provided directly on the surface of the heat-resistant layer 73 or may be provided on the heat-resistant layer 73 through another layer. The adhesive layer 74 may be provided directly on the surface of the base material layer 72 or may be provided on the base material layer 72 through a layer other than the heat-resistant layer 73. The structure of the adhesive layer 74 is not limited in particular and may be similar to the conventionally known one. The adhesive layer 74 may be a layer having higher affinity for the electrolyte solution than, for example, the heat-resistant layer 73 and swelling by absorbing the electrolyte solution. The adhesive layer 74 includes an adhesive layer binder.

As the adhesive layer binder, the conventionally known resin material with a certain degree of viscosity for the positive electrode 22 can be used without particular limitations. Specific examples include an acrylic resin, a fluorine resin, an epoxy resin, a urethane resin, ethylene vinyl acetate resin, and the like. In particular, the fluorine resin and the acrylic resin are preferable because of having high flexibility and being able to achieve the adhesiveness to the positive electrode 22 more suitably. Examples of the fluorine resin include polyvinylidene fluoride (PVdF), polytetrafluoroethylene (PTFE), and the like. The kind of the adhesive layer binder may be either the same as or different from the heat-resistant layer binder. The ratio of the heat-resistant layer binder to the total mass of the adhesive layer 74 is preferably 20 mass % or more, 50 mass % or more, and more preferably 70 mass % or more. Thus, predetermined adhesiveness for the positive electrode 22 can be achieved suitably and the separator 70 is deformed easily in the press-molding.

The adhesive layer 74 may contain another material (for example, inorganic filler given as the component of the heat-resistant layer 73) in addition to the adhesive layer binder. In a case where the adhesive layer 74 contains the inorganic filler, the ratio of the inorganic filler to the total mass of the adhesive layer 74 is preferably 80 mass % or less, more preferably 50 mass % or less, and still more preferably 30 mass % or less.

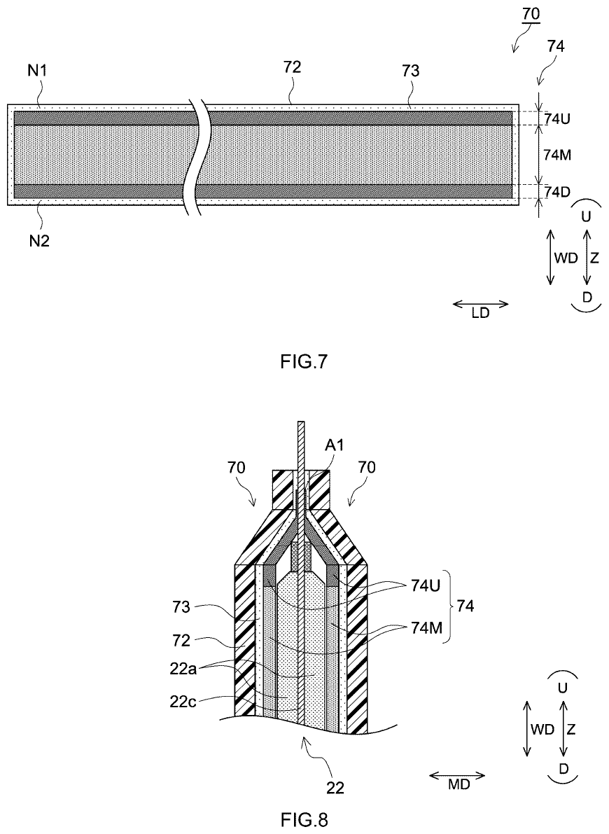

FIG. 7 is a plan view illustrating the surface of the separator 70 that is on the side facing the positive electrode 22. As illustrated in FIG. 7, the adhesive layer 74 is formed to be smaller in area than the heat-resistant layer 73 in a plan view. That is to say, the heat-resistant layer 73 is exposed to a part of the surface of the separator 70 on the positive electrode 22 side. As illustrated in FIG. 6 and FIG. 7, the adhesive layer 74 is sectioned into three regions in the winding axis direction WD here. The adhesive layer 74 includes a first formation region 74M provided at a central part in the winding axis direction WD, a second formation region 74U provided at one end part in the winding axis direction WD (upper end part in FIG. 6 and FIG. 7), and a third formation region 74D provided in the other end part in the winding axis direction WD (lower end part in FIG. 6 and FIG. 7). In the winding axis direction WD, the third formation region 74D is provided at the end part on the side opposite to the second formation region 74U. However, the third formation region 74D is not always necessary and can be omitted in another embodiment. In still another embodiment, the second formation region 74U may be provided at the lower end part in the winding axis direction WD.

As illustrated in FIG. 7, the first formation region 74M is provided between the second formation region 74U and the third formation region 74D in the winding axis direction WD. The first formation region 74M is formed in a linear shape (band shape) along the longitudinal direction LD of the separator 70. In the first formation region 74M, the surface of the adhesive layer 74 may be flat (so-called solid painting) and is preferably uneven (partially different in thickness). In the first formation region 74M, the adhesive layer 74 itself may be formed partially. In a plan view, the adhesive layer 74 is preferably formed to have a dot shape, a stripe shape, a wavy shape, a band (strip) shape, a dotted line shape, a combination of these, or the like. Thus, the impregnation of the wound electrode body 20 with the electrolyte solution can be improved. Note that, in the present specification, “the formation region is formed in a linear shape” means that the formation region is linear and the adhesive layer 74 itself may have a dot shape or the like.

The first formation region 74M is provided so as to face at least a part of the positive electrode active material layer 22a as illustrated in FIG. 6. A width A of the first formation region 74M is smaller than the width of the positive electrode active material layer 22a here. Although not particularly limited, the ratio of the width of the first formation region 74M to the width of the positive electrode active material layer 22a is preferably 0.9 to 1.1 and more preferably 0.95 to 1.05. Accordingly, the aforementioned effect, for example, at least one of the effect of suppressing the peel-off of the separator 70 and the effect of improving the vibration resistance can be achieved at a high level. From the viewpoint of suppressing the mixing of a foreign substance between the separator 70 and the positive electrode active material layer 22a at the high level, it is preferable that the second formation region 74U and an end part of the positive electrode active material layer 22a overlap substantially, and the ratio described above is preferably 0.9 to 1.0 and more preferably 0.95 to 1.0.

In the art disclosed herein, the weight per area of the adhesive layer 74 in the first formation region 74M is smaller than that of the adhesive layer 74 in the second formation region 74U. Furthermore, here, the weight per area of the adhesive layer 74 in the first formation region 74M is smaller than that of the adhesive layer 74 in the third formation region 74D. When the weight per area of the adhesive layer 74 satisfies “first formation region 74M<second formation region 74U”, the impregnation of the wound electrode body (particularly, positive electrode active material layer 22a) with the electrolyte solution can be improved and by narrowing the distance between the positive electrode 22 and the negative electrode 24, the internal resistance can be reduced.

The weight per area of the adhesive layer 74 in the first formation region 74M is g/m² or more, more preferably 0.01 g/m² or more, and still more preferably 0.02 g/m² or more, and is 2.0 g/m² or less, more preferably 1.0 g/m² or less, and still more preferably g/m² or less. Thus, the aforementioned effect can be achieved at a higher level. In the present specification, the term “weight per area” refers to the value obtained by dividing the mass of the adhesive layer 74 by the area of the formation region (the mass of the adhesive layer 74/the area of the formation region).

The second formation region 74U is provided on an upper end side relative to the first formation region 74M in the winding axis direction WD as illustrated in FIG. 7. The second formation region 74U is formed linearly (continuously) along the longitudinal direction LD of the separator 70. The second formation region 74U is formed in parallel to the first formation region 74M. The second formation region 74U is formed continuously from an upper end of the first formation region 74M. The second formation region 74U is in contact with the first formation region 74M, and in the winding axis direction WD, there is no space between the first formation region 74M and the second formation region 74U. In the second formation region 74U, the surface of the adhesive layer 74 may be either flat (so-called solid painting) or uneven. In the second formation region 74U, the adhesive layer 74 may be formed to have a dot shape, a stripe shape, or the like in a plan view. The second formation region 74U is one example of “the second formation region provided so as to protrude outward relative to one end part of the positive electrode active material layer 22a that faces the second formation region”.

As illustrated in FIG. 6, the second formation region 74U exists over the upper end of the first formation region 74M here. In the wound electrode body 20, the second formation region 74U is disposed closer to the positive electrode tab group 25 than the first formation region 74M and the third formation region 74D. The second formation region 74U forms a tab-side end part of the separator 70. In the battery 100, the second formation region 74U is disposed closer to the sealing plate 14 than the first formation region 74M and the third formation region 74D.

The second formation region 74U is provided so as to protrude upward (outward) relative to at least the upper end of the positive electrode active material layer 22a that faces the second formation region 74U. The second formation region 74U is provided so as to face the positive electrode current collector 22c (specifically, positive electrode tab 22t), for example. The second formation region 74U here faces an end part of the positive electrode active material layer 22a, the positive electrode protection layer 22p, and the positive electrode current collector 22c. The second formation region 74U is preferably in contact with the positive electrode active material layer 22a. Thus, the aforementioned effect, for example, at least one of the effect of suppressing the peel-off of the separator 70, the effect of preventing the mixing of a foreign substance, and the effect of improving the vibration resistance can be achieved at the high level, and in particular, the effect of improving the vibration resistance can be increased.

The second formation region 74U is preferably provided so as to cover the upper end of the positive electrode active material layer 22a in the winding axis direction WD. The position of the second formation region 74U in the stacking direction MD preferably overlaps with the negative electrode active material layer 24a. In other words, the upper end of the second formation region 74U is preferably disposed over (outside) the upper end of the negative electrode active material layer 24a. The width of the second formation region 74U is smaller than that of the first formation region 74M here. When a distance I1 from the upper end of the positive electrode active material layer 22a to the upper end of the negative electrode active material layer 24a (see FIG. 6) is 1 (reference), the width of the second formation region 74U is in the range of for example 0.5 to 2.5, preferably 0.8 to 2.3, and more preferably 1.0 to 2.0, although the width is not limited to this range.

The weight per area of the adhesive layer 74 in the second formation region 74U is larger than that of the adhesive layer 74 in the first formation region 74M. Thus, the contraction of the separator 70 can be suppressed suitably. The weight per area of the adhesive layer 74 in the second formation region 74U is preferably 0.005 g/m² or more, more preferably 0.01 g/m² or more, and still more preferably 0.02 g/m² or more and is preferably 2.0 g/m² or less, more preferably 1.0 g/m² or less, and still more preferably 0.05 g/m² or less. The ratio of the weight per area of the second formation region 74U to that of the first formation region 74M (second formation region 74U/first formation region 74M) is preferably 1.01 to 50, more preferably 1.10 to 30, and still more preferably 1.50 to 10. Thus, the aforementioned effect can be achieved at the higher level.

As illustrated in FIG. 7, the third formation region 74D is provided on the lower end side relative to the first formation region 74M in the winding axis direction WD. The third formation region 74D is formed linearly (continuously) along the longitudinal direction LD of the separator 70. The third formation region 74D is formed in parallel to the first formation region 74M. The third formation region 74D is formed continuously from a lower end of the first formation region 74M. The third formation region 74D is in contact with the first formation region 74M, and in the winding axis direction WD, there is no space between the first formation region 74M and the third formation region 74D. In the third formation region 74D, the surface of the adhesive layer 74 may be either flat (so-called solid painting) or uneven. In the third formation region 74D, the adhesive layer 74 may be formed to have a dot shape, a stripe shape, or the like in a plan view. The third formation region 74D is one example of “the third formation region provided so as to protrude outward relative to the other end part of the positive electrode active material layer 22a that faces the third formation region”.

The third formation region 74D exists below the lower end of the first formation region 74M here as illustrated in FIG. 6. In the battery 100, the third formation region 74D is disposed closer to the bottom wall 12a than the first formation region 74M and the second formation region 74U (in other words, on the opposite side of the sealing plate 14). The third formation region 74D forms a bottom wall side end part of the separator 70. By the provision of the third formation region 74D, the bottom wall side end part of the separator 70 can be made tough and the elasticity can be increased accordingly. Thus, the third formation region 74D functions as a cushion for the wound electrode body 20 and the vibration resistance can be improved further.

The third formation region 74D is provided so as to protrude downward (outward) relative to at least the lower end of the positive electrode active material layer 22a that faces the third formation region 74D. The third formation region 74D is provided so as to directly face another separator 70 not through the positive electrode 22, for example. The third formation region 74D here faces the end part of the positive electrode active material layer 22a and the other separator 70. The third formation region 74D is preferably in contact with the positive electrode active material layer 22a. Thus, the aforementioned effect, for example, at least one of the effect of suppressing the peel-off of the separator 70, the effect of preventing the mixing of a foreign substance, and the effect of improving the vibration resistance can be achieved at the high level, and in particular, the effect of improving the vibration resistance can be increased.

The third formation region 74D is preferably provided so as to cover the lower end of the positive electrode active material layer 22a in the winding axis direction WD. The third formation region 74D is preferably provided so as to overlap with the negative electrode active material layer 24a in the stacking direction MD. In other words, the lower end of the third formation region 74D preferably exists over (outside) the lower end of the negative electrode active material layer 24a. The width of the third formation region 74D is smaller than that of the first formation region 74M here. The width of the third formation region 74D is substantially the same as the width of the second formation region 74U here. The width of the third formation region 74D, however, may be larger than the width of the second formation region 74U, which will be described below in a modification, or may be smaller than the width of the second formation region 74U. When a distance 12 from the lower end of the positive electrode active material layer 22a to the lower end of the negative electrode active material layer 24a (see FIG. 6) is 1 (reference), the width of the third formation region 74D is in the range of for example 0.5 to 2.5, preferably 0.8 to 2.3, and more preferably 1.0 to 2.0, although the width is not limited to this range.

The weight per area of the adhesive layer 74 in the third formation region 74D is larger than that of the adhesive layer 74 in the first formation region 74M. Thus, the contraction of the separator 70 can be suppressed suitably. By the provision of the third formation region 74D with such weight per area, the aforementioned effect, for example, at least one of the effect of suppressing the peel-off of the separator 70, the effect of preventing the mixing of a foreign substance, and the effect of improving the vibration resistance can be achieved at the high level. The weight per area of the adhesive layer 74 in the third formation region 74D may be either the same as or different from that of the adhesive layer 74 in the second formation region 74U.

Although not particularly limited, the weight per area of the adhesive layer 74 in the third formation region 74D is preferably 0.005 g/m² or more, more preferably 0.01 g/m² or more, and still more preferably 0.02 g/m² or more, and preferably 2.0 g/m² or less, more preferably 1.0 g/m² or less, and still more preferably 0.05 g/m² or less. The ratio of the weight per area of the third formation region 74D to that of the first formation region 74M (third formation region 74D/first formation region 74M) is preferably 1.01 to 50, more preferably 1.10 to 30, and still more preferably 1.50 to 10. Thus, the aforementioned effects can be achieved at the higher level.

As illustrated in FIG. 6 and FIG. 7, at a tab-side end part of the separator 70 (upper end part in FIG. 6 and FIG. 7), a non-formation part N1 where the adhesive layer 74 is not formed and the heat-resistant layer 73 is exposed is provided over (outside) the second formation region 74U. By the provision of the non-formation part N1 over the second formation region 74U, a degassing property of the wound electrode body 20 can be improved and the occurrence of gas entrainment can be suppressed. A width B1 of the non-formation part N1 is smaller than the width of the second formation region 74U here. Although not particularly limited, the width B1 of the non-formation part N1 (see FIG. 6) may be about 5 mm or less and for example 1 to 3 mm, and is 1.7 mm here.

Here, as illustrated in FIG. 6, the width from the upper end of the negative electrode active material layer 24a to the upper end of the non-formation part N1 of the separator 70, that is, a protrusion allowance of the tab-side end part of the separator 70 that protrudes upward (toward the tab-side end part) relative to the upper end of the negative electrode active material layer 24a that faces the separator 70 is C1. The protrusion allowance C1 is a region of the separator 70 that does not face the negative electrode active material layer 24a. Here, the width B1 of the non-formation part N1 and the protrusion allowance C1 preferably satisfy 0<B1 C1. The width from the upper end of the positive electrode active material layer 22a, which faces the separator 70, to the upper end of the non-formation part N1 is D1. The width D1 is a region of the separator 70 that does not face the positive electrode active material layer 22a. Here, the width C1 and the width D1 typically satisfy C1<D1. Moreover, the width B1 and the width D1 preferably satisfy 0<B1 D1. The distance I1 from the upper end of the positive electrode active material layer 22a to the upper end of the negative electrode active material layer 24a is larger than the width B1 of the non-formation part N1 here. Although not particularly limited, the distance I1 may be about 5 mm or less, for example 1 to 3 mm, and is 2 mm here.

As illustrated in FIG. 6 and FIG. 7, a non-formation part N2 where the adhesive layer 74 is not formed and the heat-resistant layer 73 is exposed is provided below (outside) the third formation region 74D in the bottom wall side end part of the separator 70 (lower end part in FIG. 6 and FIG. 7). By the provision of the non-formation part N2 below the third formation region 74D, the impregnation with the electrolyte solution can be increased. A width B2 of the non-formation part N2 is smaller than the width of the third formation region 74D. The width B2 of the non-formation part N2 is smaller than the width B1 of the non-formation part N1 on the side of the tab-side end part here. Although not particularly limited, the width B2 of the non-formation part N2 may be about 5 mm or less, for example 1 to 3 mm, and is 1.6 mm here.

Here, as illustrated in FIG. 6, the width from the lower end of the negative electrode active material layer 24a to the lower end of the non-formation part N2 of the separator 70, that is, a protrusion allowance of the bottom wall side end part of the separator 70 that protrudes downward (toward the bottom wall side end part) relative to the lower end of the negative electrode active material layer 24a that faces the separator 70 is C2. The protrusion allowance C2 is a region of the separator 70 that does not face the negative electrode active material layer 24a. The protrusion allowance C2 has substantially the same length as the protrusion allowance C1 of the tab-side end part here. However, the protrusion allowance C2 may be either longer or shorter than the protrusion allowance C1. Here, the width B2 of the non-formation part N2 and the protrusion allowance C2 preferably satisfy 0<B2 C2. In addition, the width from the lower end of the positive electrode active material layer 22a, which faces the separator 70, to the lower end of the non-formation part N2 is D2. The width D2 is a region of the separator 70 that does not face the positive electrode active material layer 22a. Here, the width C2 and the width D2 typically satisfy C2<D2. Moreover, the width B2 and the width D2 preferably satisfy 0 B2 D2. The distance 12 from the lower end of the positive electrode active material layer 22a to the lower end of the negative electrode active material layer 24a is larger than the width of the non-formation part N2 here. Although not particularly limited, the distance 12 is about 5 mm or less, for example 1 to 3 mm, and 1.6 mm here.

FIG. 8 is a schematic view illustrating an upper end part of the positive electrode 22 accommodated in the battery case 10. As illustrated in FIG. 8, the tab-side end part of the separator 70 may be in a bent state within the battery case 10 in a manner that, for example, when the battery 100 is constructed, the positive electrode tab group 25 is curved or the tab-side end part of the separator 70 is brought into contact with the sealing plate 14, the internal insulating member 94 that is interposed between the sealing plate 14 and the wound electrode body 20, or the like. Here, each of the tab-side end parts of the two separators 70 that face each other is bent toward the positive electrode active material layer 22a and attached to the positive electrode current collector 22c that faces the tab-side end parts in a region A1. The upper end of the positive electrode active material layer 22a is preferably covered with the two separators 70. By the second formation regions 74U, whose weight per unit is relatively large, attached to each other through the positive electrode current collector 22c, the tab-side end parts of the separators 70 can be made tough. Thus, the interference of the positive electrode active material layer 22a with the sealing plate 14 or the internal insulating member 94 under the impact at the vibration or drop, for example, occurs less easily and the damage of the positive electrode active material layer 22a can be suppressed.

FIG. 9 is a schematic view illustrating a lower end part of the positive electrode 22 accommodated in the battery case 10. As illustrated in FIG. 9, the bottom wall side end part of the separator 70 may be in a bent state within the battery case 10 in a manner that, for example, when the battery 100 is constructed, the bottom wall side end part of the separator 70 is pressed against the bottom wall 12a of the exterior body 12 through the electrode body holder 29 or the weight of the wound electrode body 20 itself is applied. Here, the bottom wall side end parts of the two separators 70 that face each other are bent toward the positive electrode active material layer 22a and the third formation regions 74D that face each other are attached together in a region A2. The lower end of the positive electrode active material layer 22a is preferably covered with the two separators 70. Since the third formation regions 74D with the relatively large weight per area are attached to each other, the bottom wall side end part of the separator 70 can be made tough and the elasticity can be increased. Thus, the interference of the positive electrode active material layer 22a with the bottom wall 12a under the impact at the vibration or drop, for example, occurs less easily and the damage of the positive electrode active material layer 22a can be suppressed.

### Second Embodiment

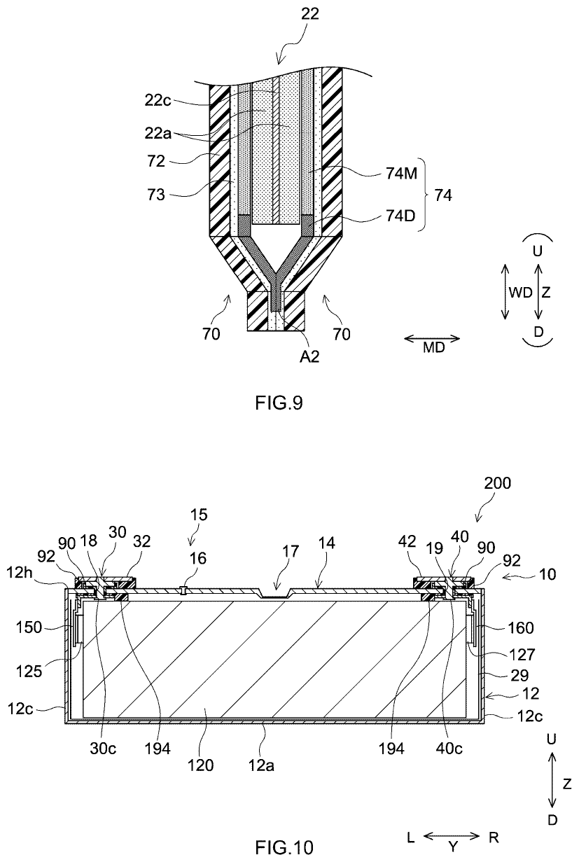

FIG. 10 is a diagram corresponding to FIG. 2 and illustrates a battery 200 according to a second embodiment. As illustrated in FIG. 10, the battery 200 includes a wound electrode body 120 instead of the wound electrode body 20. The battery 200 is different from the battery in the first embodiment in the arrangement of the wound electrode body 120.

Therefore, the battery 200 includes a positive electrode tab group 125 and a negative electrode tab group 127 instead of the positive electrode tab group 25 and the negative electrode tab group 27. The battery 200 includes a positive electrode current collecting part 150 and a negative electrode current collecting part 160 instead of the positive electrode current collecting part 50 and the negative electrode current collecting part 60. The battery 200 includes an internal insulating member 194 instead of the internal insulating member 94. Except for these points, the battery 200 may be similar to the battery 100 according to the first embodiment described above.

The wound electrode body 120 is accommodated in the battery case 10 so that the winding axis direction WD substantially coincides with the long side direction Y. In other words, the wound electrode body 120 is disposed in the battery case 10 so that the winding axis direction WD is substantially parallel to the bottom wall 12a and the sealing plate 14 and is substantially orthogonal to the long side walls 12b and the short side walls 12c. The pair of curved parts face the bottom wall 12a of the exterior body 12 and the sealing plate 14. The pair of flat parts face the long side walls of the exterior body 12. End surfaces of the wound electrode body 120 (that is, stacked surfaces where the positive electrode 22 and the negative electrode 24 are stacked) face the pair of short side walls 12c. Note that the material, structure, and the like of each part of the wound electrode body 120 may be similar to those of the wound electrode body 20 in the first embodiment.

Differently from the first embodiment, the positive electrode tab group 125 is provided at one end part in the long side direction Y (left end part in FIG. 10). The negative electrode tab group 127 is provided at the other end part in the long side direction Y (right end part in FIG. 10). The negative electrode tab group 127 is provided at an end part opposite to the positive electrode tab group 125 in the long side direction Y. The battery 200 has a so-called lateral tab structure in which the positive electrode tab group 125 and the negative electrode tab group 127 exist on the left and right of the wound electrode body 120. In the positive electrode tab group 125, the positive electrode current collecting part 150 is provided. The positive electrode tab group 125 is electrically connected to the positive electrode terminal 30 through the positive electrode current collecting part 150. In the negative electrode tab group 127, the negative electrode current collecting part 160 is provided. The negative electrode tab group 127 is electrically connected to the negative electrode terminal 40 through the negative electrode current collecting part 160.

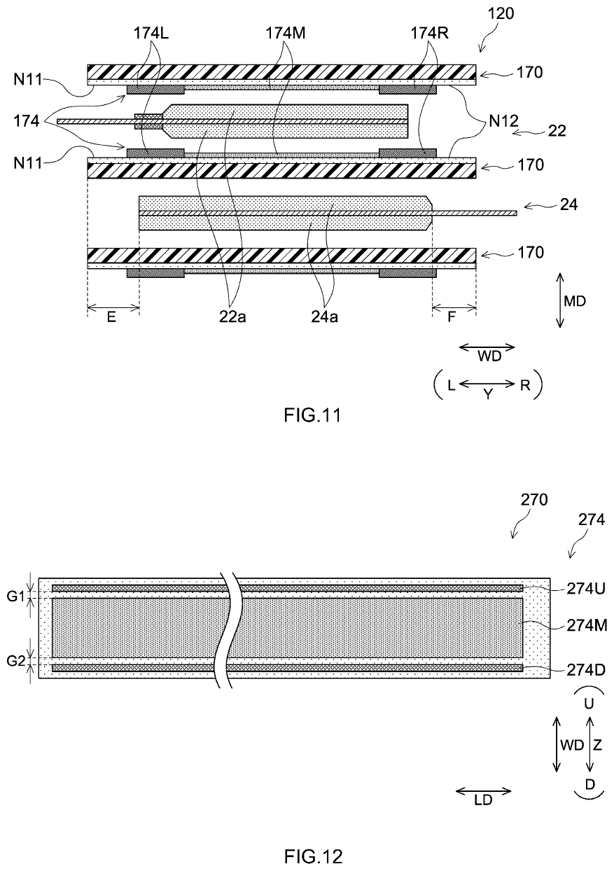

FIG. 11 is a diagram corresponding to FIG. 6 and illustrates a structure of the wound electrode body 120. Note that the reference sign WD in FIG. 11 is substantially parallel to the long side direction Y of the battery 200. A separator 170 includes an adhesive layer 174. The structure of the separator 170 may be similar to that of the separator 70 in the first embodiment described above. However, since the wound electrode body 120 is accommodated sideways in this embodiment, the different reference sign is given in order to distinguish from the first embodiment. The adhesive layer 174 is sectioned in the long side direction Y here. The adhesive layer 174 includes a first formation region 174M provided at a central part in the long side direction Y, a second formation region 174L provided at one end part in the long side direction Y (left end part in FIG. 11), and a third formation region 174R provided at the other end part in the long side direction Y (right end part in FIG. 11).

The second formation region 174L is provided at the end part on the side of the positive electrode tab group 125 here. The second formation region 174L is preferably in contact with the positive electrode active material layer 22a in a manner similar to the first embodiment. The third formation region 174R is provided at the end part on the side of the negative electrode tab group 127 here. The third formation region 174R is preferably in contact with the positive electrode active material layer 22a in a manner similar to the first embodiment. The width of the third formation region 174R may be substantially the same as that of the second formation region 174L in a manner similar to the first embodiment. The width of the third formation region 174R may be either smaller or larger than that of the second formation region 174L.

The separator 170 preferably includes a non-formation part N11 at the end part in the long side direction Y on the side where the second formation region 174L is provided, in other words, at the end part on the positive electrode tab group 125 (FIG. 10) side. In addition, the separator 170 preferably includes a non-formation part N12 at the end part in the long side direction Y on the side where the third formation region 174R is provided, in other words, at the end part on the negative electrode tab group 127 (FIG. 10) side. The provision of the non-formation part N11 and/or the non-formation part N12 makes it possible to prevent the adhesive layer binder from protruding from the separator 170 and scattering around an application device when the adhesive layer 174 is formed. In addition, at least one of the degassing property of the wound electrode body 20 and the impregnation with the electrolyte solution can be improved in a manner similar to the first embodiment.

Of the separator 170, a protrusion allowance of a positive electrode tab group side end part that protrudes to the outside of (in FIG. 11, to the left side of) the end part of the negative electrode active material layer 24a on the positive electrode tab group 125 side is E and a protrusion allowance of a negative electrode tab group side end part that protrudes to the outside of (in FIG. 11, to the right side of) the end part of the negative electrode active material layer 24a on the negative electrode tab group 127 side is F. The protrusion allowances E and F are regions of the separator 170 that do not face the negative electrode active material layer 24a. The protrusion allowance E is longer than the protrusion allowance F here. However, the protrusion allowance E may be either shorter than or substantially as long as the protrusion allowance F.

The internal insulating member 194 includes a protrusion part that protrudes toward the wound electrode body 120 from the inner side surface of the sealing plate 14. Thus, the movement of the wound electrode body 120 in the up-down direction Z is restricted. Thus, the interference of the wound electrode body 120 with the sealing plate 14 under the impact at the vibration or drop, for example, occurs less easily and the damage of the wound electrode body 120 can be suppressed.

<Application of Battery>

The battery 100 is usable in various applications, and for example, can be suitably used as a motive power source for a motor (power source for driving) that is mounted in a vehicle such as a passenger car or a truck. The vehicle is not limited to a particular type, and may be, for example, a plug-in hybrid electric vehicle (PHEV), a hybrid electric vehicle (HEV), or a battery electric vehicle (BEV). The battery 100 can be used suitably for constructing an assembled battery because the variation in battery reaction is reduced.

Although some embodiments of the present disclosure have been described above, these embodiments are just examples. The present disclosure can be implemented in various other modes. The present disclosure can be implemented based on the contents disclosed in this specification and the technical common sense in the relevant field. The techniques described in the scope of claims include those in which the embodiments exemplified above are variously modified and changed. For example, a part of the aforementioned embodiment can be replaced by another modified aspect, and the other modified aspect can be added to the aforementioned embodiment. Additionally, the technical feature may be deleted as appropriate unless such a feature is described as an essential element.

<First Modification>

For example, in the adhesive layer 74 of the separator 70, the second formation region 74U is formed continuously from the upper end of the first formation region 74M and there is no space between the first formation region 74M and the second formation region 74U in FIG. 7 described above. In addition, the third formation region 74D is formed continuously from the lower end of the first formation region 74M and there is no space between the first formation region 74M and the third formation region 74D. However, the structure is not limited to this example. In a first modification, an adhesive layer non-formation region where the adhesive layer 74 is not formed may be provided between the first formation region 74M and the second formation region 74U and/or between the first formation region 74M and the third formation region 74D.

FIG. 12 is a diagram corresponding to FIG. 7 and illustrates a separator 270 according to the first modification. An adhesive layer 274 of the separator 270 includes a first formation region 274M, a second formation region 274U, and a third formation region 274D. In the separator 270, a gap G1 is formed between the first formation region 274M and the second formation region 274U and a gap G2 is formed between the first formation region 274M and the third formation region 274D. Except for this point, the separator 270 may be similar to the aforementioned separator 70. The provision of the gap G1 and/or the gap G2 can improve the permeation of the electrolyte solution and/or the degassing property. The gaps G1 and G2 are formed linearly (in a band shape) along the longitudinal direction LD of the separator 270. Although not limited in particular, each of the gaps G1 and G2 is preferably 5 mm or less, more preferably 2 mm or less, and still more preferably 1 mm or less and is preferably 0.05 mm or more and more preferably 0.1 mm or more.

<Second Modification>

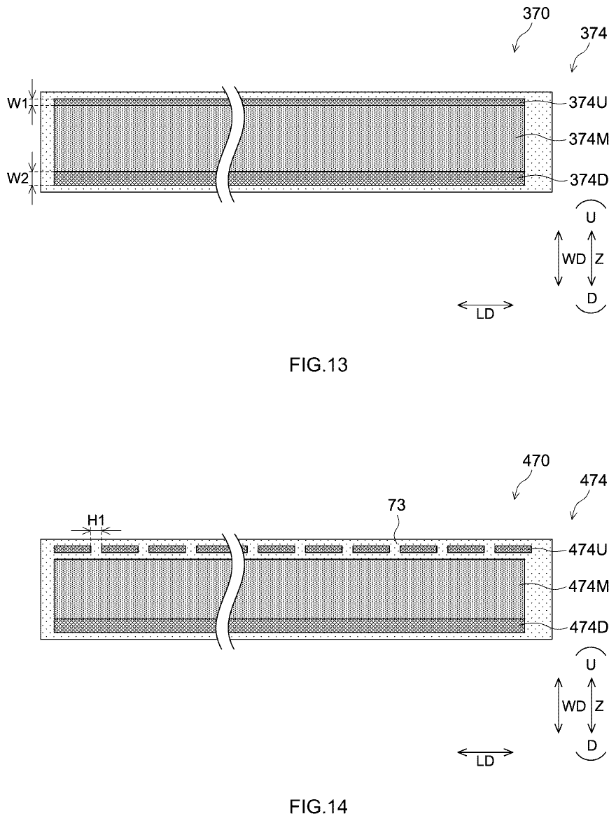

For example, the width of the third formation region 74D is substantially the same as that of the second formation region 74U in FIG. 7 described above; however, the structure is not limited to this example. FIG. 13 is a diagram corresponding to FIG. 7 and illustrates a separator 370 according to a second modification. An adhesive layer 374 of the separator 370 includes a first formation region 374M, a second formation region 374U, and a third formation region 374D. In the separator 370, a width W2 of the third formation region 374D is larger than a width W1 of the second formation region 374U. Except for this point, the separator 370 may be similar to the aforementioned separator 70. By increasing the width of the third formation region 374D, the elasticity of a bottom wall side end part of the separator 370 can be increased and the higher vibration resistance can be achieved. Although not limited in particular, the ratio of the width W2 to the width W1 (W2/W1) may be about 1.2 to 3.0 and for example about 1.5 to 2.0.

<Third Modification>

For example, the second formation regions 274U and 374U are formed continuously along the longitudinal direction LD of the separators 270 and 370 in FIG. 12 and FIG. 13 described above, respectively. However, the structure is not limited to this example. FIG. 14 is a diagram corresponding to FIG. 7 and illustrates a separator 470 according to a third modification. An adhesive layer 474 of the separator 470 includes a first formation region 474M, a second formation region 474U, and a third formation region 474D. In the separator 470, the second formation region 474U is formed with a predetermined space H1 (intermittently) along the longitudinal direction LD. The interval H1 is the adhesive layer non-formation region where the second formation region 474U is not provided. In the interval H1, the heat-resistant layer 73 is exposed. Except for this point, the separator 470 may be similar to the aforementioned separator 70. Although not limited in particular, the length of the interval H1 in the longitudinal direction LD may be, for example, 5 mm or more or 10 mm or more.

In one example, the interval H1 is provided at a portion that is disposed below (right under) the gas discharge valve 17 in the vertical direction when the separator 470 is accommodated in the battery case 10. This structure makes it easier for the gas to flow toward the gas discharge valve 17 and the gas in the battery case 10 can be discharged to the outside quickly. Thus, the safety can be improved. In another example, the interval H1 is provided at a portion that is disposed below (right under) the liquid injection hole 15 in the vertical direction when the separator 470 is accommodated in the battery case 10. Thus, the impregnation with the electrolyte solution can be improved. In another example, the interval H1 is provided at a portion that is disposed in the curved part 20r when the wound electrode body 20 with a flat shape is manufactured. Thus, an elastic action caused by the curved part 20r after the press molding can be suppressed and the force of restoring to the cylindrical shape (so-called spring back) can be suppressed.

<Fourth Modification>

For example, the second formation region 74U and the third formation region 74D are in contact with the positive electrode active material layer 22a in FIG. 6 in the first embodiment described above. However, the structure is not limited to this example. In another example, the second formation region 74U may not be in contact with the positive electrode active material layer 22a. In this case, the effect of improving the vibration resistance can be increased and moreover, the degassing property of the wound electrode body 20 can be improved and the occurrence of gas entrainment can be suppressed. Furthermore, the impregnation with the electrolyte solution can be increased. In addition, the third formation region 74D may not be in contact with the positive electrode active material layer 22a. In this case, the effect of improving the vibration resistance can be increased and moreover, the impregnation with the electrolyte solution can be increased.

In FIG. 11 in the second embodiment described above, the second formation region 174L and the third formation region 174R are in contact with the positive electrode active material layer 22a. However, the structure is not limited to this example. The second formation region 174L and/or the third formation region 174R may not be in contact with the positive electrode active material layer 22a. In this case, the impregnation with the electrolyte solution can be increased and moreover, the degassing property of the wound electrode body 120 can be improved and the occurrence of gas entrainment can be suppressed.

<Fifth Modification>

In the first embodiment and the second embodiment described above, the electrode body 20 is a wound type (wound electrode body) including the band-shaped positive electrode 22 and the band-shaped negative electrode 24. However, the structure is not limited to this example. The electrode body can be a stacked type (stacked electrode body) in which typically a plurality of square positive electrode plates and square negative electrode plates are stacked in the insulated state.

As described above, the following items are given as specific aspects of the art disclosed herein.

Item 1: The battery including the electrode body including the positive electrode including the positive electrode active material layer, the negative electrode including the negative electrode active material layer, and the separator, and the battery case with the cuboid shape for accommodating the electrode body, in which the separator includes the adhesive layer at least on the surface that faces the positive electrode. The adhesive layer includes the first formation region provided so as to face the positive electrode active material layer, and the second formation region provided so as to protrude outward, in the up-down direction or the long side direction of the battery, relative to one end part of the positive electrode active material layer that faces the first formation region, and the adhesive layer in the first formation region has smaller weight per area than the adhesive layer in the second formation region.

Item 2: The battery according to Item 1, in which the second formation region is in contact with the positive electrode active material layer.

Item 3: The battery according to Item 1 or 2, in which the adhesive layer further includes the third formation region provided so as to protrude outward, in the up-down direction or the long side direction of the battery, relative to the other end part of the positive electrode active material layer that faces the first formation region, and the adhesive layer in the first formation region has smaller weight per area than the adhesive layer in the third formation region.

Item 4: The battery according to Item 3, in which the third formation region is in contact with the positive electrode active material layer.

Item 5: The battery according to Item 3 or 4, in which the battery case includes the exterior body including the opening, the bottom wall that faces the opening, and the side wall extending from the edge side of the bottom wall to the opening, and the sealing plate that seals the opening, the electrode body is disposed in the battery case so that the second formation region exists on the side of the sealing plate and the third formation region exists on the side of the bottom wall, and the width of the third formation region is larger than the width of the second formation region in the up-down direction of the battery.

Item 6: The battery according to any one of Items 1 to 5, in which the second formation region is formed intermittently along the up-down direction of the battery.

Item 7: The battery according to Item 6, in which the battery case includes the exterior body including the opening, the bottom wall that faces the opening, and the side wall extending from the edge side of the bottom wall to the opening, and the sealing plate that includes the gas discharge valve and seals the opening, and the portion where the second formation region is not formed exists below the gas discharge valve in the vertical direction.

Item 8: The battery according to Item 6 or 7, in which the battery case includes the exterior body including the opening, the bottom wall that faces the opening, and the side wall extending from the edge side of the bottom wall to the opening, and the sealing plate that includes the liquid injection hole for the electrolyte solution, and seals the opening, and the portion where the second formation region is not formed exists below the liquid injection hole in the vertical direction.

### REFERENCE SIGNS LIST

10 Battery case
12 Exterior body
14 Sealing plate
20 Wound electrode body
22 Positive electrode
22a Positive electrode active material layer
22c Positive electrode current collector
24 Negative electrode
24a Negative electrode active material layer
24c Negative electrode current collector
170, 270, 370, 470 Separator
72 Base material layer
73 Heat-resistant layer
74, 174, 274, 374, 474 Adhesive layer
74M, 174M, 274M, 374M, 474M First formation region
74U, 174L, 274U, 374U, 474U Second formation region
74D, 174R, 274D, 374D, 474D Third formation region
100 Battery

What is claimed is:

1. A battery comprising:
an electrode body including a positive electrode including a positive electrode active material layer, a negative electrode including a negative electrode active material layer, and a separator; and
a battery case with a cuboid shape for accommodating the electrode body, wherein
the separator includes an adhesive layer at least on a surface that faces the positive electrode,
the adhesive layer includes a first formation region provided so as to face the positive electrode active material layer, and a second formation region provided so as to protrude outward, in an up-down direction or a long side direction of the battery, relative to one end part of the positive electrode active material layer that faces the first formation region, and
the adhesive layer in the first formation region has smaller weight per area than the adhesive layer in the second formation region.

2. The battery according to claim 1, wherein the second formation region is in contact with the positive electrode active material layer.

3. The battery according to claim 1, wherein
the adhesive layer further includes a third formation region provided so as to protrude outward, in the up-down direction or the long side direction of the battery, relative to the other end part of the positive electrode active material layer that faces the first formation region, and
the adhesive layer in the first formation region has smaller weight per area than the adhesive layer in the third formation region.

4. The battery according to claim 3, wherein the third formation region is in contact with the positive electrode active material layer.

5. The battery according to claim 3, wherein
the battery case includes an exterior body including an opening, a bottom wall that faces the opening, and a side wall extending from an edge side of the bottom wall to the opening, and a sealing plate that seals the opening,
the electrode body is disposed in the battery case so that the second formation region exists on a side of the sealing plate and the third formation region exists on a side of the bottom wall, and
a width of the third formation region is larger than a width of the second formation region in the up-down direction of the battery.

6. The battery according to claim 1, wherein the second formation region is formed intermittently along the up-down direction of the battery.

7. The battery according to claim 6, wherein
the battery case includes an exterior body including an opening, a bottom wall that faces the opening, and a side wall extending from an edge side of the bottom wall to the opening, and a sealing plate that includes a gas discharge valve and seals the opening, and
a portion where the second formation region is not formed exists below the gas discharge valve in a vertical direction.

8. The battery according to claim 6, wherein
the battery case includes an exterior body including an opening, a bottom wall that faces the opening, and a side wall extending from an edge side of the bottom wall to the opening, and a sealing plate that includes a liquid injection hole for an electrolyte solution, and seals the opening, and
a portion where the second formation region is not formed exists below the liquid injection hole in a vertical direction.
